(19) United States
(12) Patent Application Publication
(10) Pub. No.: US 2016/0289971 A1
(43) Pub. Date: Oct. 6, 2016

(54) COATING COMPOSITION AND SYSTEM FOR RENEWAL OF ASPHALT SHINGLE ROOFS AND METHOD OF APPLICATION THEREOF

(71) Applicant: CREATIVE MATERIAL TECHNOLOGIES LTD., Palmer, MA (US)

(72) Inventor: John C. BECKER, IV, Monson, MA (US)

(73) Assignee: CREATIVE MATERIAL TECHNOLOGIES LTD., Palmer, MA (US)

(21) Appl. No.: 15/085,189

(22) Filed: Mar. 30, 2016

Related U.S. Application Data
(60) Provisional application No. 62/140,019, filed on Mar. 30, 2015.

(51) Int. Cl. E04D 7/00; B05D 1/38; B05D 7/00; D06N 5/00; B05D 1/02

(52) U.S. Cl. CPC E04D 7/00; D06N 5/00; B05D 1/02; B05D 7/5483; B05D 1/38; D10B 2101/06; D10B 2505/20

(57) ABSTRACT

A composite structure includes a substrate, a first coating layer arranged on the substrate, and a second coating layer arranged on the first coating layer such that the first coating layer is between the substrate and the second coating layer. The composite structure may further include a third coating layer and an aggregate layer arranged on the second coating layer. A method of forming a composite structure includes applying a coating mixture by spray or by rolling, brushing or squeegeeing to a substrate, partially dissolving the substrate, thereby allowing the coating mixture to partially mix with the substrate to form a first coating layer on the substrate; and forming a second coating layer from the coating compound on the first coating layer.

### TECHNICAL FIELD

The present disclosure relates to an engineered coating composite system, coating components, composite coating composition, and methods of application thereof; and in particular, the use of a polyurea, polyurethane, epoxy, or hybrids thereof used to partially dissolve existing asphalt shingles thus forming an organic-inorganic inter-penetrating network composite finished with inorganic aggregate for appearance and functional purposes.

### BACKGROUND

Since the beginning of human evolution mankind has sought to find shelter for protection of life and property. The history of material invention and development reads as a novel for improving mankind's survivability and comfort. Once the need for protection from the elements was satisfied, then the drive changed to providing greater comfort at lower costs. As mankind in developed nations achieved a level of comfort in their living environments, the focus in building construction began to center around the character and personality of the home. Now, as we have entered into the 21^{st} century, the home building envelope is again under evolution as the demand is not only for the home to protect us from the elements and potential intruders, but also to provide a level of energy savings to assist us in managing the increasing costs of heating and cooling the home building, while still maintaining a level of security and comfort.

Throughout the history of the building envelope development, the roof has obtained and maintained a position of prominence in that building envelope. From mud, grass thatch, and turf-based roofs, to stone, tile, wood, asphalt, membrane, and finally asphalt shingle roofs, the constant motivating factor has been longevity of service life, and therefore a lower cost per year of service while maintaining an architecturally pleasing appearance. In the recent past, economic and geopolitical events have made it more difficult for many to maintain their homes in the manner in which they desire.

For residential purposes, many homes in the United States and other developed countries have settled upon the asphalt shingle as the preferred low-cost roofing product solution. Asphalt shingle manufacturers have, in the past several years, had to concentrate on reformulating roof shingles to meet new and higher threshold fire prevention and environmental standards that have resulted in a shingle with a shorter life, a lower content level of bitumen asphalt, a higher architectural detail level, and higher performance against fire.

A growing trend in roofing is roof coating. Paint, coatings and compositions thereof have been used for multiple purposes from anti-ballistic coatings to anti-corrosion coatings to automotive coatings but generally have all shared in the demand that a coating protects the substrate to which it is applied. In fact, it is difficult to find any man-made object that does not utilize a coating of some description for protection or other functionality. It is commonly believed that the paint and coatings industry is actually two industries: the paint industry, which is dominated in the consumer's mind by the architectural paint sector, and the coatings industry, which is the home for high-performance polymeric coatings centered around high solids and low VOC (volatile organic compounds) coating compositions. The word coating, in the singular or plural form, shall refer to high-performance polymeric coatings for the balance of this document.

A number of paint and coating compositions have been marketed for and used in roof coating applications with mixed results. No paint or coating composition known has been able to blend the necessary properties required for a complete restoration of both function and appearance for an asphalt shingle roof.

For example, Clemens (PCT/US01/44497) teaches a composite designed as a field applied engineered composite system coating including, as one of its components, a thermosetting urethane-epoxy hybrid basecoat coating. The coating system described in Clemens includes a urethane/epoxy basecoat formulation to be asphalt extended chemically cross-linked requiring between 10 and 90%, preferably 20 and 70%, and most preferably 30 and 60% of a petroleum asphalt.

Senkfor (U.S. Pat. No. 7,928,160) teaches a similar polyurea/polyurethane coating composition. Further, Senkfor teaches the addition of a flame retardant.

Paints that are water-borne or solvent-borne usually do not possess the vapor permeation rate to adequately waterproof a roof—either pitched or flat. Further, low crosslinked polymeric coatings, for example, acrylic and PVA (polyvinyl acetate) systems have difficulty in resisting sag or long term flow on pitched roofs. Highly cross-linked systems, while outperforming low crosslinked systems in vapor permeation and long term flow problems, also fail in the present application in regards to the inability to adhere properly to an asphalt shingle or provide long term protection from weather erosion and solar radiation degradation effects. Some aliphatic polyureas, polyurethanes, and polyurea/polyurethane hybrids, while possessing better solar radiation resistance are usually too fast setting to allow proper wet out (the conformity of a coating to a topological profile of the substrate so as to minimize voids in mechanical adhesion) of the asphalt shingle thus preventing a good adhesion profile and also too fast setting to allow the application of aggregate to the coating that helps to preserve the architectural detail of the asphalt roof shingle.

### SUMMARY

In view of the problems described above, there exists a need for a coating composition that can be chemically bonded to the existing asphalt shingle substrate. In addition, there is a need for a restorative roof coating process that allows the coating composition to be applied to a substrate such as an asphalt shingle “in situ” and under ambient conditions, to maintain the architectural detail of the existing asphalt shingle. In addition, a restorative roof coating process is needed that will allow a wet out profile and open time that will enable a roofing aggregate to be applied and obtain excellent adhesion to the coating composition.

It is a first objective of this disclosure to provide a restorative non-asphaltic spray coating system over existing asphalt shingle roofs and fiberglass shingle roofs as a field applied system.

It is a second objective of this disclosure to provide a protective non-asphaltic spray coating system over new asphalt shingles as an OEM or factory applied system.

It is a third objective of this disclosure to provide a field applied non-asphaltic spray coating system onto existing asphalt shingle roofs which will become a layer in a multilayer engineered composite roof system as a field applied, infield created composite roof system. This engineered composite roof system will be comprised of four layers including a base existing substrate layer, a trans-substrate-coating composite layer, a coating layer, and an optional final aggregate layer.

It is the fourth objective of this disclosure to provide systems as described above in the first three objectives whereby the method of application is a non-spray method.

There are several performance criteria that allow for an effective restoration or renewal of existing or new asphalt shingle roofs. These will be described herein as it is demonstrated that the present application possesses those performance criteria necessary for the effective restoration or renewal of asphalt shingle roofs.

The first of these performance criteria is to obtain a chemical adhesive bond to the substrate that is stronger than paint and coatings can obtain through a mechanical bond such as a bond obtained by the coating wetting out the substrate and conforming to the substrate topography. The required chemical adhesive bond quantitatively varies due to a variety of different asphalt shingle products with differing weather profiles and stages of wear. Generally, the adhesive bond strength of the coating to the asphalt shingle substrate should exceed the cohesive strength of the substrate.

The second of these performance criteria is the ability to maintain an elongation profile sufficient to prevent cracking or delamination of the coating from the coating/substrate interface, while maintaining a tensile strength sufficient to withstand the effects of weather, abrasion, and impact. Cracking or deformation may be caused by various forces including differential thermal expansion between the coating and the shingle substrate. The standard in high-performance asphalt shingles stands at 800% elongation with flexibility at temperatures of 0° F. (−18° C.). Therefore, the minimum elongation profile required to prevent cracking delamination would be expected to be below 800% since the adhesive strength at the coating-substrate interface would allow some shear force to absorb the differential in maximum elongation performance. Further, flexibility down to 0° F. (−18° C.) would be in the expected flexibility parameter to ensure that no cold impact cracking occurs.

The third of these performance criteria is the ability to possess a high cross-linked density through the use of high solids coating compositions to reduce the vapor permeation and enhance the waterproofing characteristics of the roof system. It is expected that a solid contents in excess of 95% will be necessary to achieve this performance criteria. Further for purposes of environmental and fire safety it would be desirable but not mandatory to minimize the solvent content and the VOC content of the coating composition.

The fourth of these performance criteria is the ability to possess sufficient weather resistance to allow a long term service life as the coating roof system will be called upon to resist weather erosion, UV exposure, and related coating degradation forces.

The fifth of these performance criteria is to possess the ability to spray without significant overspray and the resulting wind drift. This performance criterion involves the understanding of the spray process that creates aerosolization versus the spray process that creates atomization. Aerosol is considered present where the average particle size of the airborne liquid particle is sub-micron (less than 1 μm). Atomization is considered to be the spray process being utilized when the average particle size of the airborne liquid particle is greater than 1 μm. Modifications in the calculation of the average particle distribution in the physics involved in Reynolds number and Stokes law and associated equations are necessary when dealing with aerosols of solid liquids. Coating compositions that contain near zero solvents and near zero water are examples of materials that can be called a solid liquid since the word solid in this case is a descriptor of the material and not an indication of the physical state of the material.

Aerosolization occurs when materials that have low viscosity are sprayed at higher pressures; when materials that that are heated and therefore the viscosity drops are sprayed at higher pressures; when materials are sprayed with a low flow rate; or when materials are sprayed at a very high pressure. These concepts of these relationships are described in FIGS. 3, 5 and 6. The preferred method for the practice of this disclosure is to spray the materials without aerosolization. In outdoor environments aerosolization creates property hazards liability, health and safety hazards liability, and a higher likelihood of a discontinuous film which will retard performance.

Property hazards liability occur from aerosolization when material is sprayed and aerosolized in outdoor environments or indoor environments and air movement, commonly called “wind drift” moves the material in the air from the target substrate area to the surrounding property. This wind drift aerosol will land on personal and real property resulting in damage and increased cost of operation.

Health and safety hazards increase when aerosol is present since reactive components can be inhaled and damage the linings of a person's lungs. OSHA (Occupational Safety and Health Administration) has established requirements for the use of personal protective equipment (respirators) to protect installers from inhaling aerosols of these reactive components. The aerosol of these reactive components can cause a discontinuous film through the mechanism of carbon dioxide (CO₂) production that follows the following chemical reaction equation: NCO+H₂O→CO₂+NH₂.

As the particle size decreases the aggregated surface area of the sprayed material increases dramatically. This increase in aggregated surface area of the sprayed material interacts with the air that the sprayed material is passing through and hence, with the moisture that is in that air volume and as a result of that moisture reaction produces carbon dioxide (CO₂). The CO₂ is carried into the polymer film and creates gaseous voids within the polymer film that negatively impacts the performance properties of that polymer film. For example, the polymer film's tear strength will decrease, tensile strength will decrease, and UV and mechanical degradation rates will increase.

Therefore, it is desirable to minimize or eliminate aerosolization of the sprayed compositions. FIG. 4 represents the relationship of particle size versus spray pressure. Also shown in FIG. 4, notations are made for the three different stages that can be seen as the spray pressure increases. At the lowest spray pressures, no visible aerosol is present. As the spray pressure increases, a photo-reflective aerosol becomes present. As the spray pressure increases further a visible aerosol becomes evident in the spray area.

A photo-reflective aerosol is an airborne aerosol that the human eye cannot easily see that becomes readily apparent when a flash picture is taken and then one can see the light reflecting from the flash back to the lens of the photographic equipment. Data points from physical spray testing are reflected in FIG. 4.

The sixth of these performance criteria is the open time or working time that the coating material possesses after being mixed and deposited onto a substrate and wetting out that substrate to receive an application by broadcast or spray of a silica sand or aggregate so that sufficient bond will be achieved between the coating layer and the aggregate layer so as to prevent any disbondment of the aggregate from the coating layer.

The seventh of these performance criteria is the method of application wherein an improvement in existing spray equipment is utilized to provide a spray pattern at an angle of 0 to 180° from the resulting vertex running along a horizontal line of the roof substrate and in a form of a line focused +/−45 degrees from perpendicular to the plane of that substrate. The resulting spray pattern of this disclosure significantly reduces overspray and wasted material in that it eliminates circular spray patterns of all kinds and replaces a circular spray pattern with a rectangular spray pattern where the base of the rectangle is less than the height of the rectangle. FIG. 11 shows the improvement in spray pattern and the resulting decrease in material waste and overspray.

Other criteria, secondary objectives, and advantages incorporated into this disclosure shall become evident as the description of this disclosure continues.

The substrate for this disclosure includes asphalt and fiberglass shingles but also includes any asphaltic/bituminous substrate such as roll-on roofing tar.

The components used for certain embodiments of this disclosure include components that have high solids in their design, are able to achieve high cross-linking, can resist vertical sag, and can be applied at a thickness that is necessary to receive an aggregate for both functional and appearance purposes. Examples of these components include epoxy, polyurethane, polyurea, and the hybrids, hyperbranched, or dendritic structures thereof. Dendritic or hyperbranched polymer structures enable performance properties necessary for this disclosure at lower film thicknesses than would be required from the compositions of epoxy, polyurethane, polyurea and/or hybrid coatings known in the art.

The application equipment used in the spray embodiment of this disclosure include both single and plural component spray equipment that can achieve the necessary spray pressure to material flow relationships as would be appropriate for atomized systems. The application equipment used in the non-spray embodiment of this disclosure include both extrusion and hand applied tools such as rollers, brushes and/or squeegees that can achieve the appropriate finish desired by the application.

In view of the above, various embodiments of the present application include a composite structure comprising a substrate, a first coating layer arranged on the substrate, and a second coating layer arranged on the first coating layer such that the first coating layer is between the substrate and the second coating layer. The substrate may comprise at least one substrate material selected from the group consisting of an asphalt shingle, a fiberglass shingle, asphalt, a bituminous material, roofing tar, EPDM, roofing paper, TPO, PVC, ketone ethylene ester, and a siding material. The second coating layer may comprise at least one coating material selected from the group consisting of an acrylic resin, a PVDF resin, a polyurea resin, a polyurethane resin, an epoxy resin, a polyurea-polyurethane hybrid resin, and combinations and hybrids thereof. The first coating layer may comprise a mixture of the at least one substrate material and the at least one coating material.

In other embodiments, the composite structure may further comprise a third coating layer comprising at least one coating material selected from the group consisting of an acrylic resin, a PVDF resin, a polyurea resin, a polyurethane resin, an epoxy resin, a polyurea-polyurethane hybrid resin, and combinations and hybrids thereof.

In other embodiments, the composite structure may further comprise an aggregate layer arranged on the second coating layer. The aggregate layer may comprise at least one aggregate material selected from the group consisting of inorganic sands, silica sand, silicas, silicates, oxides, coal slag, glass microspheres, ceramics, ceramic microspheres, abrasive media, photoluminescence aggregate, IR reflective aggregate, organo-metallics, polyurea, polyurethane, epoxy, PVDF, PVC, PC, TPO, PTFE, and particulate minerals.

The aggregate layer may be one that reflects, diffracts, or absorbs at least one of ultraviolet radiation, visible light and infrared radiation.

The second coating layer may have a thickness in a range of from 5 mils to 250 mils. The third coating layer has a thickness in a range of from 5 mils to 250 mils.

Another embodiment of the present application includes a method of applying a coating to a substrate. The method may comprise steps of spraying a coating mixture comprising a coating compound and a dissolving solvent onto the substrate; partially dissolving the substrate with the dissolving solvent, thereby allowing the coating mixture to partially mix with the substrate to form a first coating layer on the substrate; and forming a second coating layer from the coating compound on the first coating layer.

The first coating layer, second coating layer and aggregate layer may be as listed above. The dissolving solvent is a solvent that is at least partially miscible with the second coating layer and is capable of at least partially dissolving the substrate material. The dissolving solvent may include at least one selected from the group consisting of acetone, methylethylketone, tetrachloroethylene, butyl acrylate, dibutyl amine, lacquer solvent, methylene chloride, naptha, tetrachloroethylene, acetone, diesel fuel, amyl chloride, ethylene chloride, n-butyl acetate, methyl isobutyl ketone, chlorobenzene, dibutyl phthalate, toluene, and xylenes.

In other embodiments, the coating compound comprises a first reactant and a second reactant. The first reactant may comprise a precursor compound comprising at least two isocyanate groups, and the second reactant may include at least one selected from the group consisting of a compound having more than one primary or secondary amine, a compound having more than one alcohol group, and a compound having more than one aspartic ester group.

The second reactant may have a hyperbranched or a dendrimer structure. In certain embodiments, an average particle size of coating compound may be greater than 1 μm when the coating mixture is sprayed onto the substrate. In other embodiments, the average particle size of coating compound may be from 1 μm to 5 mm when the coating mixture is sprayed onto the substrate.

The solvent may have a concentration of 0.1 vol % to 20 vol % in the coating mixture. In other embodiments, the solvent may have a concentration of 1.5 vol % to 3.9 vol % in the coating mixture. In other embodiments, the solvent may have a concentration of 0.05 vol % to 1.0 vol % in the coating mixture.

The ratio of equivalents of the first reactant to equivalents of the second reactant in the coating mixture may be from 0.95:1 to 1:0.95. In other embodiments, the ratio of equivalents of the first reactant to equivalents of the second reactant in the coating mixture may be from 0.95:1 to 1.40:1. In yet other embodiments, the ratio of equivalents of the first reactant to equivalents of the second reactant in the coating mixture may be from 0.98:1 to 1.15:1.

In certain embodiments, the coating mixture may be sprayed onto the substrate with a spray pattern that has a rectangular cross-section. The coating mixture may be sprayed at a spray pressure of from 2 psi to 40 psi. In other embodiments, the coating mixture may be sprayed at a spray pressure of from 35 psi to 350 psi. In yet other embodiments, the coating mixture may be sprayed at a spray pressure of from 350 psi to 3500 psi.

In other embodiments, the coating mixture may be applied onto the substrate by rolling, brushing or squeegeeing.

### BRIEF DESCRIPTION OF THE DRAWINGS

FIG. 1 is a “Trans-Substrate-Coating Composite Structure” diagram (Diagram #1) showing the layers and structure of the composite in its final form according to one embodiment of the present disclosure.

FIG. 2 is a graph demonstrating the relationship between the cohesive strength of the Trans-Substrate-Coating Layer and the amount of dissolving solvent in vol % required to form a composite structure.

FIG. 3 is a generalized graph indicating the relationship between the particle size and material temperature on the atomization/aerosolization threshold of a liquid for use as a coating composition according to certain embodiments of the present disclosure.

FIG. 4 is a graph indicating the general relationship between particle size and spray pressure on the atomization/aerosolization threshold of a liquid for use as a coating composition according to certain embodiments of the present disclosure along with specific data points established through this disclosure.

FIG. 5 is a generalized graph indicating the relationship between particle size and material viscosity on the atomization/aerosolization threshold of a liquid for use as a coating composition according to certain embodiments of the present disclosure.

FIG. 6 is a generalized graph indicating the relationship between particle size and material flow rate on the atomization/aerosolization threshold of a liquid for use as a coating composition according to certain embodiments of the present disclosure.

FIG. 7 is a graph showing the adhesion of urethane coating to an asphalt shingle substrate using various dissolving solvents according to certain embodiments of the present disclosure.

FIG. 8 is a graph showing the adhesion of polyurea coatings to an asphalt shingle substrate with and without the use of TCE dissolving solvent according to certain embodiments of the present disclosure.

FIG. 9 is a conventional spray nozzle for use with coating compositions according to certain embodiments of the present disclosure.

FIG. 10 is a spray nozzle used to spray a coating composition according to another embodiment of the present disclosure.

FIG. 11 is a representative diagram showing a spray pattern of coating compositions using the spray nozzles shown in FIGS. 9 and 10.

### DETAILED DESCRIPTION OF THE EMBODIMENTS

The substrate layer may be comprised of an asphalt roofing shingle where the composition of that shingle is as is commonly available in the industry. In other embodiments, the substrate layer may be any asphalt/bitumen roof coating or material regardless of how it is applied.

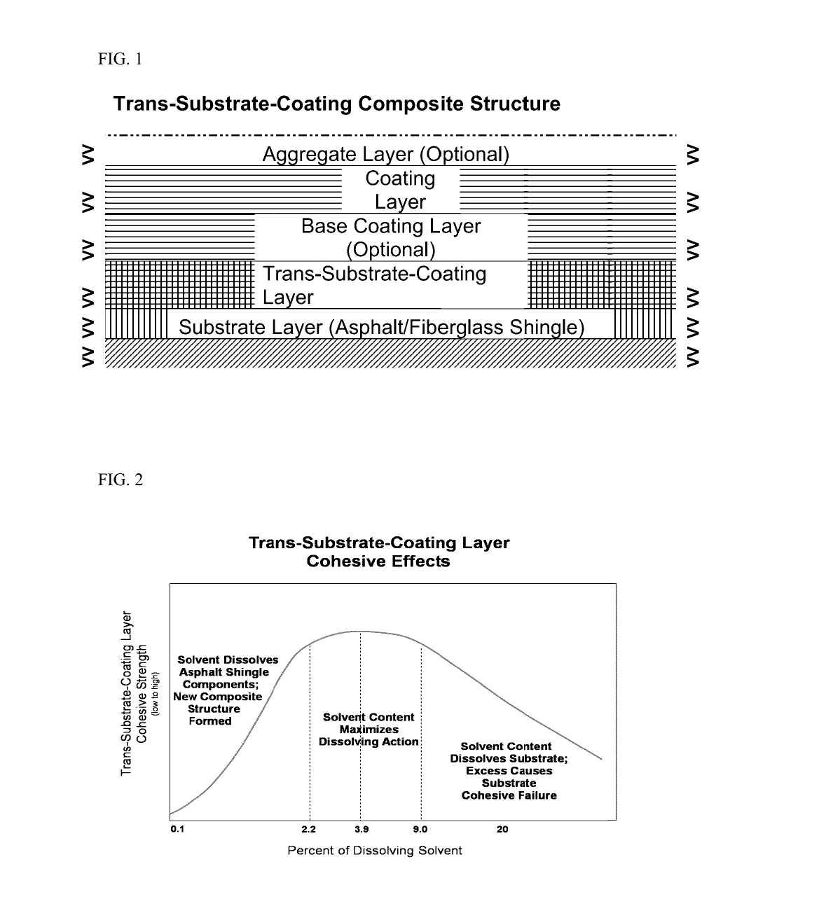

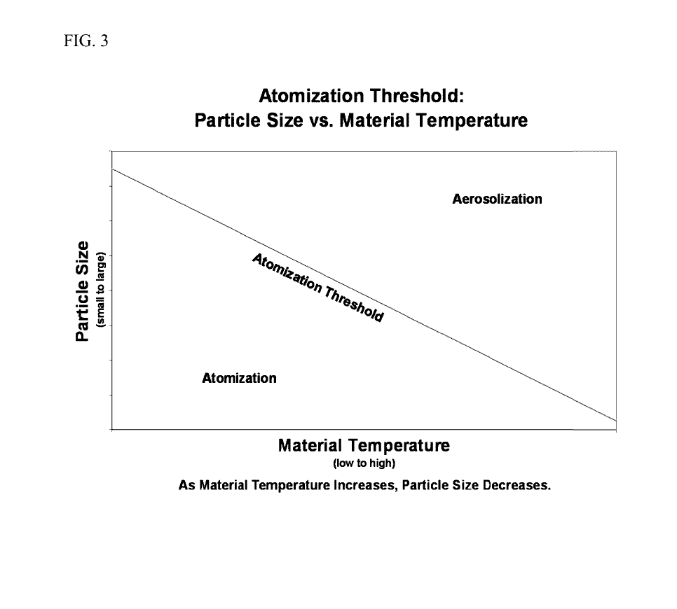

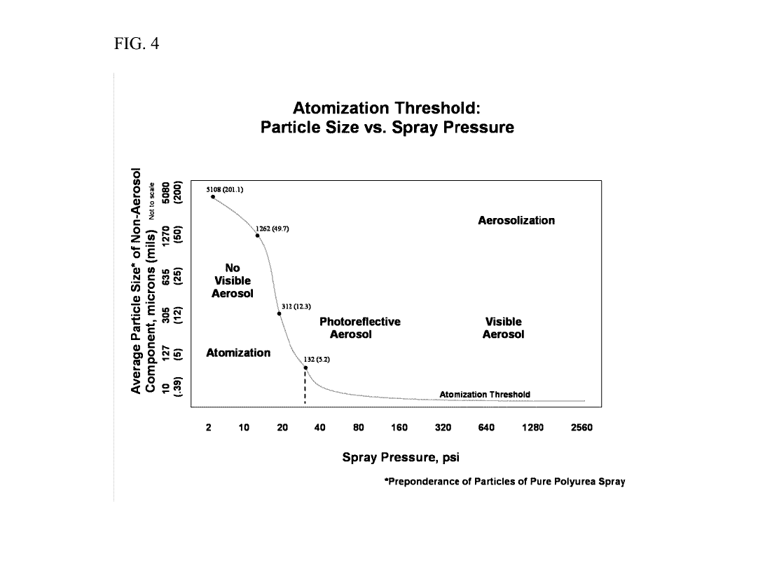

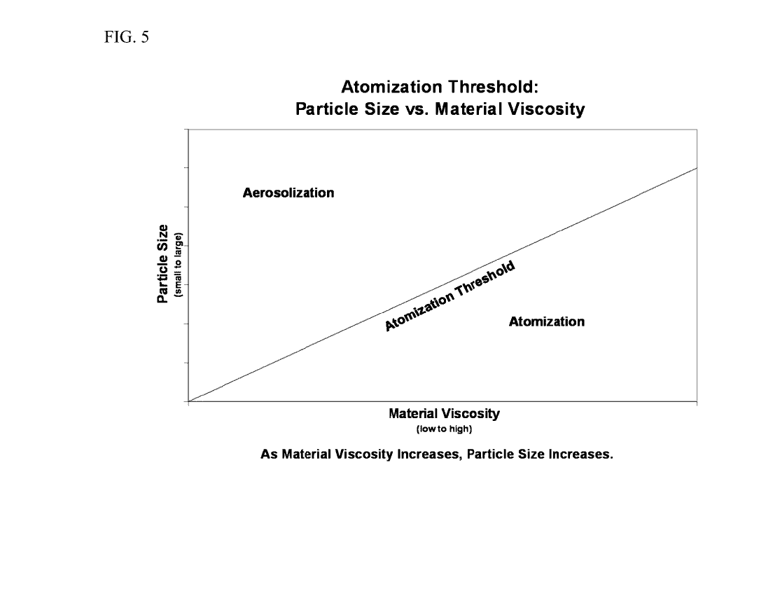

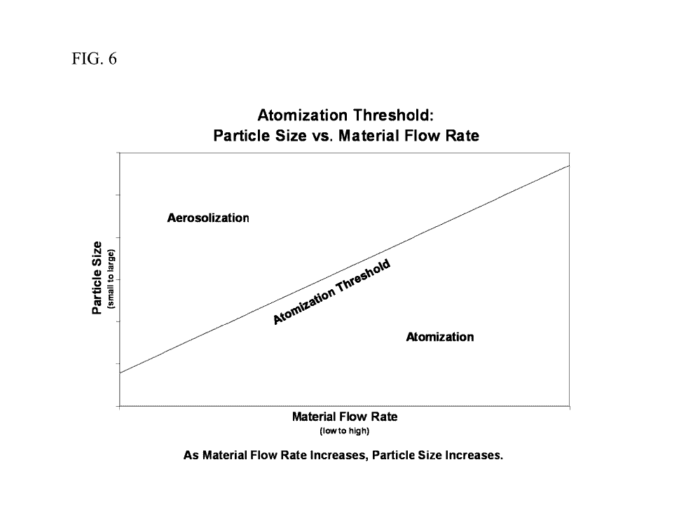

FIG. 1 shows a Trans-Substrate-Coating Composite Structure according to an embodiment of the present disclosure. The Trans-Substrate-Coating Layer is a layer at the interface of the Substrate Layer and the Base Coating Layer, and is formed from components of the Substrate Layer and the Base Coating Layer. The mechanism for forming the Trans-Substrate-Coating Layer is described below. The Trans-Substrate-Coating layer is created in place from the components of the layer above it and below it and has no outside compositional matter added to it. In certain embodiments, the substrate is a pre-existing asphalt shingle on a building or other structure.

The Base Coating Layer may include formulations including the examples attached hereto having compounds that is selected to possess the necessary physical properties as described earlier of elongation, flexibility at 0° F. (−18° C.), weather and UV resistance, and open time to receive the aggregate layer. The system may be designed so that the Base Coating Layer may be applied on those systems requiring a higher film build for waterproofing or other performance criteria, such as storm/hurricane damage resistance. If the performance criteria do not exist for a particular application then the Coating Layer is designated as the Base Coating Layer and therefore components of the Coating Layer and the Substrate Layer will react to form the Trans-Substrate-Coating Layer. In applications that require higher performance and thereby require both a Base Coating Layer and a Coating Layer, then the Coating Layer when applied to the Base Coating Layer forms a chemical bond so as to not create and inter-coat adhesive failure between these two layers.

The present disclosure also can utilize a urethane/epoxy hybrid as its Base Coating Layer and/or its Coating Layer. However, the present disclosure does not incorporate asphalt material composition components into the basecoat formulation. Asphalt compositional matter is part of the Trans-Substrate-Coating Layer after the dissolving solvent has dissolved the asphalt shingle to a degree where the asphaltic compositional material of the asphalt shingle and the components of the Base Coating Layer can mix, thus creating the Trans-Substrate-Coating Layer. The Trans-Substrate-Coating Layer may also include a trans-organic-composite structure.

The Aggregate Layer may possess the properties of reflectance, absorption, or diffraction of light wavelengths within the ultraviolet through infrared light wavelength spectrum. In certain embodiments, the Aggregate Layer of the structure may include silica sand, inorganic media such as coal slag, glass microspheres, ceramic microspheres, abrasive media, photoluminescent aggregate, minerals, or any other material that is in a solid shape granular or particulate form, either spherical or articulated. The Aggregate Layer may be formed when the aggregate is broadcast either through mechanical, pneumatic, or airborne gravity mechanism into the Coating Layer while the Coating Layer has not yet reached a durometer that would resist the wetting out and bonding to the aggregate. If faster setting materials are used in the Coating Layer that a pneumatic aggregate gun may be necessary in order to force the aggregate into the setting Coating Layer.

Historically, when it has been desirable to apply an aggregate onto a surface to increase the coefficient of slip resistance or to increase the environmental and/or exposure resistance of the underlying organic coating by providing an inorganic covering over that coating, the preferred method of aggregate application has been by depositing the aggregate onto the surface of the coating through an air assist style of application equipment, allowing the aggregate, with gravity, to come to rest onto the surface of the coating. This method of application has provided the aggregate a surface contact with the coating, and displaced, depending upon the pressure at which the aggregate landed onto the surface of the coating, the viscosity of the coating, and the angle of contact, a certain amount of said coating. The greater the displacement of coating material with the aggregate particle, the greater the contact area of that aggregate particle with the coating material. As the contact area of the aggregate particle with the coating material increases, so does the mechanical bonding properties of that aggregate particle with the coating material, provided that the coating material can wet the aggregate surface, and thereby can provide mechanical bonding.

It has become known to those that are familiar with this process that the greater the pressure that distributes the aggregate material into the coating surface, and indeed propels the aggregate material into the coated surface, the greater the resulting mechanical bonding properties. One problem that has arisen with this realization is that if an applicator “shoots” the aggregate into the uncured and low viscosity coating surface, that the aggregate may become buried into the coating thickness and eliminate the value of the aggregate being placed onto the coating surface. Therefore, much work has been done to try to time the distribution of the aggregate onto the coating surface or to increase the amount of time that the coating stays viscous enough to hold the aggregate without fully reacting so that the coating may properly wet out the aggregate.

Conventional methods, such as in U.S. Pat. No. 4,539,049, teach the use of organosilanes for the purpose of increasing adhesion of certain polymers to dissimilar substrates. Typically, extended reaction times at elevated temperatures of 50 to 120° C. are required to accomplish the necessary chemical reactions for an organosilane to modify the surface of the substrate to which it is intended to bond. The chemical reactions necessary for an organosilane to modify the surface of the substrate are 1) hydrolysis; 2) condensation; 3) hydrogen bonding; and 4) bond formation. The bond formation that is created is a silicone type of bond formation including silyl and silanol types.

However, in the present application, under certain parameters, the extended reaction times at elevated temperatures are not required. Instead, extended reaction times of more than 20 fold at ambient temperatures will achieve similar bond formation if assisted by exothermic reaction, increased surface area contact, or by pretreatment of the aggregate itself. The hydrolysis chemical reaction step that is required for an organosilane to allow condensation into oligomeric form, which is a precursor to forming covalent bonds to achieve chemical bonding to the substrate, can be disrupted or prevented with an insufficient amount of moisture, available either in the substrate or through moisture penetration or absorption into the polymer film itself. Therefore, organic resins that are known to possess very low vapor permeation rates may experience problems with full hydrolysis of the organosilane, and thus poor performance in achieving appropriate bonding properties. These organic resins are typically high solids, high cross-linking, exothermic reacting resin systems such as polyurethane, polyurea, and epoxies.

The present application was realized through the understanding that if an aggregate particle achieved sufficient mechanical bond through the wetting out process and was sufficiently wetted out by the polymer receiving the aggregate particle to become stable in its mechanical bonding, and sufficient moisture was available to allow the organosilane to begin the hydrolysis reaction, then over time, that organosilane would, through condensation, form the necessary oligomer groups that would then hydrogen bond to the hydroxyl groups in epoxies, polyureas, and/or polyurethanes, and would result in a covalent bond structure between the aggregate particle and the receiving polymer resin. The enhanced bonding properties provided through the present application reduce or eliminate the need for increased working times, stability of viscosities, or forcing the applicator to apply the aggregate at a precise moment in time to achieve the desired effect.

Similarly, amino functional metal oxides are a class of adhesion promoters useful in achieving a chemical bond by ad between dissimilar materials wherein the dissimilar materials include an isocyanate functional resin system, such as is common with polyurethane, polyurea, and epoxies; and any inorganic material that may be surface modified to enable a chemical bonding of that inorganic material bound to the chelated aluminum moiety and the zirconium moiety of the amino functional metal oxide. The amino functional ligand will bond into the isocyanate with the typical reaction product being a polyurea species while the inorganic material being bonded will be surface modified and bonded as described above. Excess moisture present in the reaction site may deter the proper bonding properties from forming since that excess moisture will preferentially react with the isocyanate and produce the byproducts of carbon dioxide (CO₂) and an amine (NH₂) thus providing a surplus of amine functional groups. The present disclosure demonstrates that, when moisture is managed through the deposition of the inorganic material into the surface of the coating body with a small distance between the surface and the deposition discharge point of the application equipment being used, bonding properties are optimized. In addition, articulated inorganic materials that promote additional three-dimensional thread structures with the amino functional metal oxide seem to outperform spherical non-threading type of structures.

The Coating Layer must have a thickness sufficient to ensure coverage of the asphalt or asphalt shingle. In certain embodiments, the thickness is in a range of from about 5 to about 250 mils or 5 mils to 250 mils, and in other embodiments, the thickness is in a range of from about 10 mils to about 160 mils or 10 mils to 160 mils. If waterproofing or storm resistance properties are required, the thickness should generally be in a range of from about 40 mils to about 210 mils, or 40 mils to 210 mils. If no water proofing is needed, the thickness can be from 20 mils to 30 mils, or about 20 mils to about 30 mils. These thicknesses can also vary depending on the age and type of the substrate, and the climate the substrate is in.

The Aggregate Layer of the structure is integral to and acts as the first functional component of the surface solar radiation heat resistance disclosure incorporated herein. The Aggregate Layer may provide a surface topography that rests above the top surface of the Coating Layer. In some embodiments, the Aggregate Layer may be comprised of inorganic materials that may be spherical or articulated and in particulate form. The Aggregate Layer actively reflects, diffracts, and/or absorbs the UV (ultraviolet), Visible Light and IR (infrared) wavelengths of the light wavelength spectrum. The majority of heat from solar radiation emitted from the sun is in the UV through the IR ranges of the light wavelength spectrum. As the Aggregate Layer actively limits heat wavelengths from reaching the Coating Layer directly, then the Aggregate Layer has a cooling effect on the system.

A second functional component of the surface solar radiation heat resistance disclosure is the Coating Layer. The UV through IR wavelengths that are able to reach the Coating Layer around the topological profile of the Aggregate Layer may then reach the Coating Layer. The Coating Layer contains an IR reflective solid solutions (pigment) composition covered by U.S. Pat. No. 6,174,360 (Sliwinski, et al) and U.S. Pat. No. 6,454,848 B2 (Sliwinski). Sliwinski teaches solid solutions having corundum-hematic crystalline structures that can reflect IR wavelengths.

Trials with a variety of solvent-based systems have indicated a chemical reaction producing foam structures within the coating film. It is believed that the crystalline structure of the Infrared Reflective Color Pigment provides interfacial crevices whereby solvent, and thereby residual moisture within the miscible solvent is retained until it latently reacts with moisture sensitive reactive materials such as the isocyanates and polyisocyanates utilized by some of the examples herein. This disclosure has eliminated the difficulty of bubbles/foaming resulting from the utilization of the Infrared Reflective Color Pigment disclosed by Sliwinski.

The Base Coating Layer is applied as discussed earlier either in a spray or non-spray method. The base coating layer dissolves the substrate layer so as to create a new Trans-Substrate-Coating Layer whereas this layer is a composite of composition combining both the Substrate Layer and the Base Coating Layer. The Base Coating Layer may contain a dissolving solvent such as TCE (tetrachloroethylene also known as perchloroethylene) in a concentration level between 0.1% and 20%. The dissolving solvent may be dispersed throughout the coating of the Base Coating Layer and as it dissolves the asphaltic and bitumen components of the asphalt shingle, the dissolving solvent solubilizes the reactive components of the coating, thereby creating a mixture that comprise a new composite. The dissolving solvent may be consumed through this reaction and evaporated off as a result of the exotherm of the reactive components. Upon evaporation, the dissolving solvent leaves behind a mixture of the organic hydrocarbons, monomers, oligomers, and inorganic species known to be present in asphaltic/bituminous materials and the reacted components of the base component of the coating of The Base Coating Layer.

The composition of asphalt shingles have changed in the past several years as fire prevention standards have become more stringent. Modern shingle have less of the flammable asphaltic/bituminous materials present in older asphalt shingles, and now contain less flammable fibers and other binding materials. This has resulted in a wide spectrum of asphalt concentrations in the asphalt shingles that are still in service on roofs today. Therefore, the optimum level of dissolving solvent for each given asphalt shingle compositional formula may be determined when applying the material in the field. A range of dissolving solvent that is most appropriate to be incorporated into the disclosure provided that the upper range of the dissolving solvent does not negatively impact the cohesive strength of The Substrate Layer. As is shown in FIG. 2, the preferred concentration and preferred practice of the disclosure is a dissolving solvent concentration level between 1.5% and 3.9%. Higher dissolving solvent concentrations of The Base Layer on older high asphalt containing shingles is appropriate but not mandatory. It should be noted that high concentrations of dissolving solvent within The Base Layer coating applied to newer shingles that contain low asphalt levels will reduce and compromise the cohesive strength of the substrate.

In certain embodiments of the present application, the dissolving solvent may be at least one selected from the group consisting of acetone, methylethylketone, tetrachloroethylene, butyl acrylate, dibutyl amine, lacquer solvent, methylene chloride, naptha, tetrachloroethylene, acetone, diesel fuel, amyl chloride, ethylene chloride, n-butyl acetate, methyl isobutyl ketone, chlorobenzene, dibutyl phthalate, toluene, and xylenes.

FIG. 2 demonstrates the relationship of the dissolving solvent concentration level within the coating of the Base Coating Layer and the substrate. At low levels of concentration the dissolving solvent is able to dissolve the asphaltic/bituminous materials of the asphalt shingle and create an “in situ” composite without the use of forms or other curing mechanisms or equipment. At medium levels of concentration the dissolving solvent is able to dissolve the asphaltic/bituminous materials of the asphalt shingle and create a “in situ” composite that is thicker and more complete than the low level of concentration of dissolving solvent is able to create. At high levels of concentration the dissolving solvent dissolves the asphaltic/bituminous materials of the asphalt shingle and when a composite would begin to form further dissolves that composites matrix so as to compromise the cohesive strength of that composite that constitutes the Trans-Substrate-Coating Layer and the cohesive strength of the substrate itself.

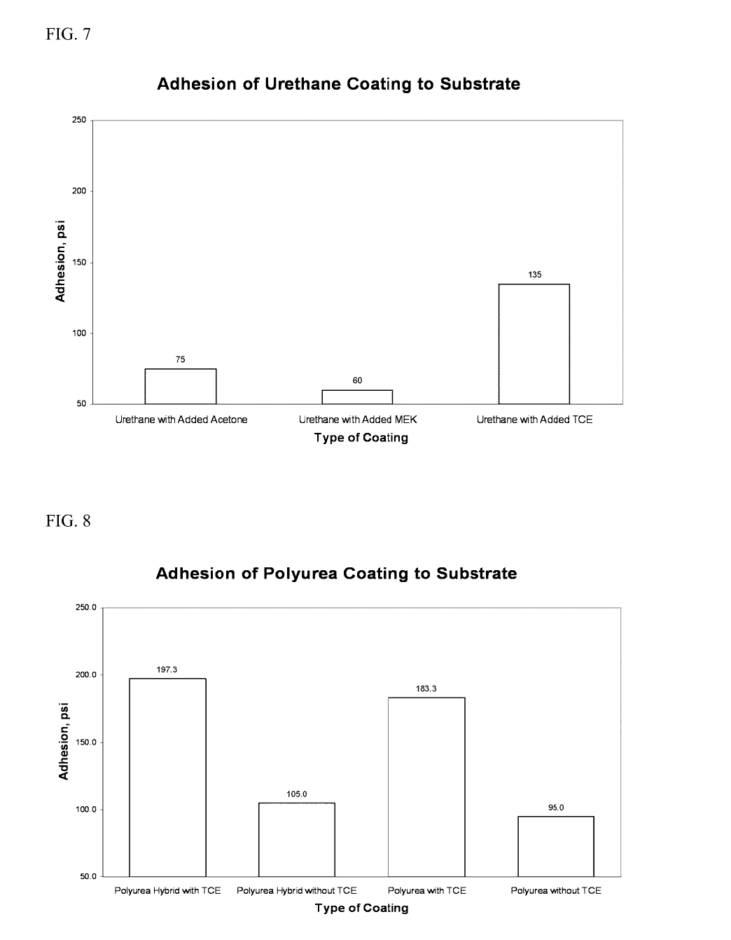

FIG. 7 is a graph showing the adhesion of urethane coating to an asphalt shingle substrate using acetone, methyl ethyl ketone and TCE as dissolving solvents. FIG. 8 is a graph showing the adhesion of polyurea coatings to an asphalt shingle substrate with and without the use of TCE as a dissolving solvent. As is seen from this graph, the use of solvents allows for better adhesion of the coating to the substrate.

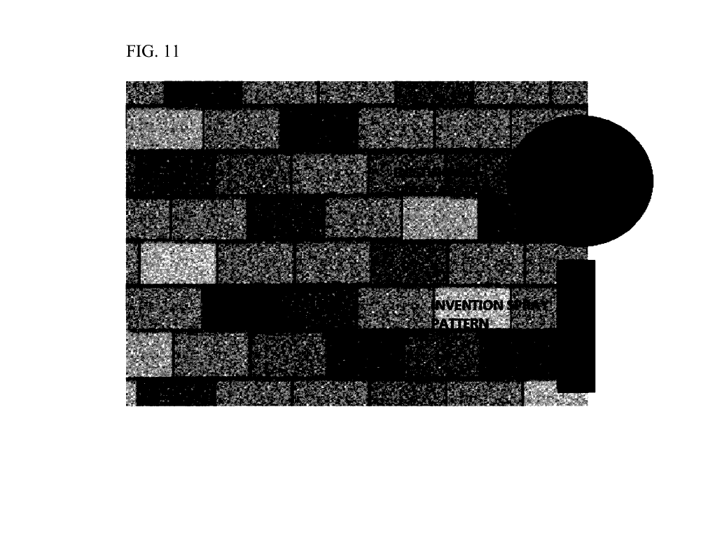

This disclosure relates to the improvement in the existing art which allows two component material to be sprayed through a static mixing element and then forced through a pressurized air chamber where the pressurized air accelerates the flow rate of the material to create a spray pattern. The existing art produces a spray pattern that is circular in shape. When spraying substrates that have a fixed edge, these circular spray patterns produce a 50% waste factor of material being sprayed and increases the hazards of overspray and wind drift as the result of spraying “off target”. FIG. 11 shows a representation of the material waste and spraying “off target”. Off target refers to when a spray pattern is spraying at any surface other than the desired surface to be sprayed.

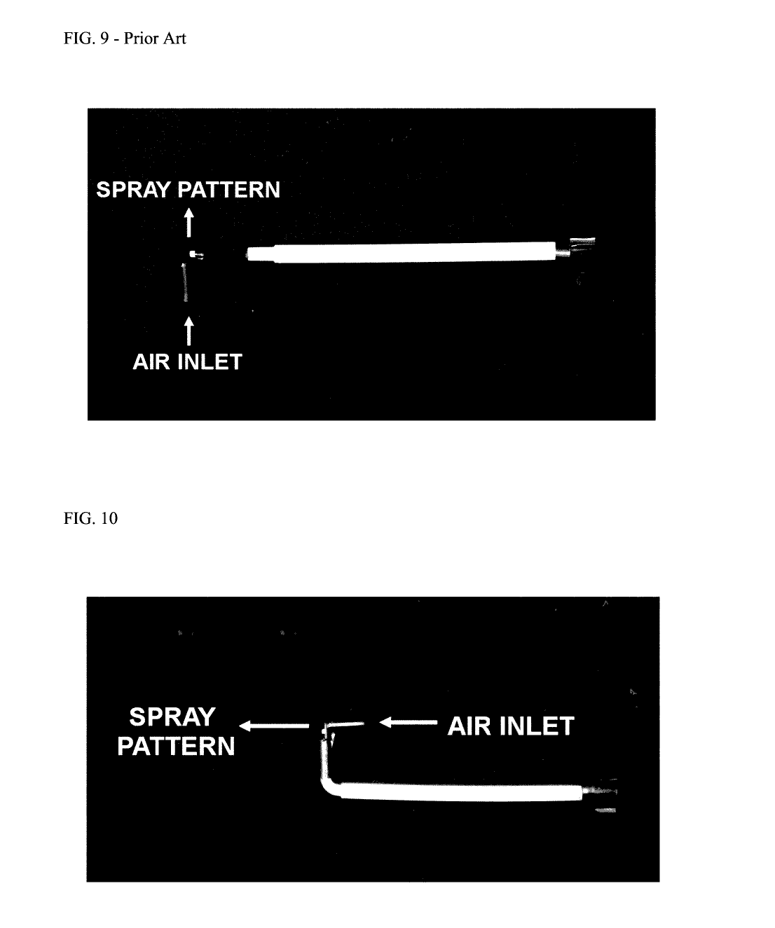

It would be desirable to enable a spray pattern that would be linear or rectangular in shape and could be applied at a 180° angle from the spray gun or parallel to the spray gun. Existing art provides for a 90° spray tip which will spray with a linear spray pattern. However, in order to spray a surface that is perpendicular to the normal operating orientation of the spray gun it would require holding and operating the spray gun at a 90° angle to your body and parallel to the plane of the substrate being sprayed. This would at times be difficult and produce physical applicator stress as well as potential coating application failure. By improving the design of an existing static mixing element and spray tip, these difficulties have been reduced or eliminated. This disclosure allows a linear spray pattern at 180° angle from the spray gun or parallel to the spray gun. FIGS. 9 and 10 show both the existing art and the new art and clearly represent the design improvements in the existing art.

The Base Coating Layer and/or Coating Layer may be comprised of polyurea components as further described herein. Polyurea consists of a two-part reactant system wherein one reactant is an isocyanate (also known as a hardener) and the other reactant is a polyamine (also known as a resin).

The Base Coating Layer and/or Coating Layer may be comprised of polyurethane components as further described herein. Polyurea consists of a two-part reactant system wherein one reactant is an isocyanate (also known as a hardener) and the other reactant is a polyol (also known as a resin).

The Base Coating Layer and/or Coating Layer may be comprised of epoxy components as further described herein. Polyurea consists of a two-part reactant system wherein one reactant is known as a hardener and the other reactant known as a resin).

The Base Coating Layer and/or Coating Layer may be comprised of polyurea hybrid or polyurethane hybrid components as further described herein. These hybrids are mixtures of polyurea components and polyurethane components. These hybrids will contain a hardener and a resin.

The Base Coating Layer and/or Coating Layer may be comprised of epoxy hybrid components as further described herein. These hybrids are mixtures of polyurea and/or polyurethane components and epoxy components. These hybrids will contain a hardener and a resin.

Other embodiments of the present disclosure involve a coating composition comprising a polyurea formed from a reaction mixture including an isocyanate-functional component and an amine-functional component. The ratio of equivalents of isocyanate groups to equivalents of amine groups may be greater than or equal to 0.95. The isocyanate-functional component and the amine-functional component can be applied to a substrate at a different volume mixing ratios. For example, the volume mixing ratios of the isocyanate-functional component and the amine-functional component may range from 0.3:1 to 1:0.3 depending upon the formulation and embodiment.

At least 0.5 percent by weight of the isocyanate-functional component comprises at least one polyisocyanate monomer. The isocyanate-functional component may also include an isocyanate-functional polyisocyanate prepolymer. The isocyanate-functional polyisocyanate prepolymer may be a reaction product of a polyisocyanate and a polyol or an amine, and wherein the amine-functional component is selected from aliphatic polyamines, aromatic polyamines, mono- and poly-acrylate and methacrylate modified amines, polyaspartic ester-based polyamines, and/or polyoxyalkylene amines.

The coating composition may also include a polyurethane in the case of polyurea/polyurethane hybrids. In other embodiments, the coating composition may be free of polyurethane in the case of pure polyurea compositional coating formulations.

The coating composition may also include a dissolving solvent component as described above.

### EXAMPLES

The following examples describe various specific embodiments of the present disclosure. These examples do not limit the present disclosure.

### Example 1

Formula:
Aromatic Polyurethane Hybrid

| | | % | Vol- |
|---|---|---|---|
| Formula Components A | | NCO | ume |
| Methylenediphenyl Diisocyanate | | 15.2 | 100 |
| (High 2,4 isomer) | | | |
| Totals | | | 100 |
| | Specific | | Vol- |
| Formula Components B | Gravity | MW | ume |
| Diethyltoluene Diamine | | 178 | 6.70 |
| Glyceryl poly(oxypropylene) triamine | | 5000 | 6.84 |
| Polyether Diol | | 2000 | 5.71 |
| Polyether Diol | | 1000 | 44.75 |
| Polyether Polyol | | 350 | 25.82 |
| FeO - Black | 5 | 0 | 1.51 |
| Thermally Modified Quartz (95+% | 2.33 | 0 | 7.48 |
| SiO2) | | | |
| Organosilane | | | 0.5 |
| Organoclay - Dry | 1.6 | 0 | 0.68 |
| Totals | | | 100 |

### Example 2

Formula:
Aromatic Pure Polyurea

| | Specific | % | Vol- | |
|---|---|---|---|---|
| Formula Components A | Gravity | NCO | ume | Index |
| Methylenediphenyl Diisocyanate | | 15.2 | 90.00 | |
| (High 2,4 isomer) | | | | |
| Alumino-silicate glass | 2.4 | 0 | 10.00 | |
| Totals | | | 100.00 | 0.9805 |
| | Specific | | Vol- | |
| Formula Components B | Gravity | MW | ume | |
| Diethyltoluene Diamine | | 178 | 4.74 | |
| Polyoxypropylenediamine | | 2000 | 20.80 | |
| Glyceryl poly(oxypropylene) | | 5000 | 7.67 | |
| triamine | | | | |
| N,N′-dialkylamino-diphenyl- | | 310 | 45.47 | |
| methane; 4,4′Bis(sec-butyl- | | | | |
| amino)diphenylmethane | | | | |
| N,N′-bis(2-propyl)Polyoxy- | | 2050 | 9.67 | |
| propylenediamine | | | | |
| Silicone-Free Defoamer/Deaerator | 0.91 | 0 | 0.50 | |
| Organosilane | | | 0.50 | |
| Alumino-silicate glass | 2.4 | 0 | 9.50 | |
| FeO2-Black | 5 | 0 | 1.16 | |
| Totals | | | 100 | |

### Example 3

Formula:
Aliphatic Pure Polyurea (w/Aspartic Ester)

| | Specific | % | Vol- |
|---|---|---|---|
| Formula Components A | Gravity | NCO | ume |
| Hexamethylene Diisocyanate Trimer | | 23 | 67.29 |
| (HDI Homopolymer) | | | |
| Isophorone Diisocyanate | | 4 | 22.55 |
| Propylene Carbonate | 1.2 | 0 | 9.53 |
| Silicone-Free Defoamer/Deaerator | 0.91 | 0 | 0.63 |
| Totals | | | 100.00 |
| | Specific | MW | Vol- |
| Formula Components B | Gravity | (EW) | ume |
| Aspartic Ester & Aliphatic Carboxylic | | (279) | 66.83 |
| Ester Blend | | | |
| Aliphatic Polyimine | | (182) | 30.20 |
| 2-(3-heptyl)-N-butyl-1,3-oxazolane | | (114) | 2.49 |
| Silicone-Free Defoamer/Deaerator | 0.91 | 0 | 0.48 |
| Totals | | | 100 |

### Example 4

Formula:
Aliphatic Polyurethane

| | Specific | % | Vol- |
|---|---|---|---|
| Formula Components A | Gravity | NCO | ume |
| Hexamethylene Diisocyanate Trimer | | 23 | 67.07 |
| (HDI Hompolymer) | | | |
| Propylene Carbonate | 1.2 | 0 | 10.84 |
| Acetone | 0.79 | 0 | 22.09 |
| Totals | | | 100.00 |
| | Specific | | Vol- |
| Formula Components B | Gravity | MW | ume |
| 2-oxepanone, polymer with 1,4 butanediol | | 400 | 93.49 |
| Dioctyltin Laurate | 1.08 | 0 | 0.98 |
| 2-(3-heptyl)-N-butyl-1,3-oxazolane | | (114) | 2.40 |
| N-[3-(Trimethoxysilyl)Propyl]Ethylene- | | 226 | 0.51 |
| diamine | | | |
| Silicone-Free Defoamer/Deaerator | 0.91 | 0 | 1.15 |
| UV Inhibitors & Antioxidants Blend | 1.06 | 0 | 1.48 |
| Totals | | | 100.00 |

### Example 5

Formula:
Aromatic Polyurea Hybrid - Preferred

| | Specific | % | Vol- |
|---|---|---|---|
| Formula Components A | Gravity | NCO | ume |
| Methylenediphenyl Diisocyanate | | 15.2 | 96.36 |
| (High 2,4 isomer) | | | |
| Tetrachloroethylene | 1.62 | 0 | 3.06 |
| Zirconium Chelate Complex | 0.98 | 0 | 0.58 |
| Totals | | | 100.00 |
| | Specific | MW/ | Vol- |
| Formula Components B | Gravity | (EW) | ume |
| N,N′-dialkylamino-diphenyl- | | 310 | 11.37 |
| methane; 4,4′Bis(sec-butyl- | | | |
| amino)diphenylmethane | | | |
| N,N′-bis(2-propyl)Polyoxy- | | 2050 | 11.70 |
| propylenediamine | | | |
| 2-oxepanone, polymer with 2,2- | | 1000 | 26.67 |
| bis(hydroxymethyl)-1,3-propanediol | | | |
| Aspartic Ester & Aliphatic Carboxylic | | (290) | 35.99 |
| Ester Blend | | | |
| Silicone-Free Defoamer/Deaerator | 0.91 | 0 | 1.23 |
| N-[3-(Trimethoxysilyl)Propyl]Ethylene- | | 226 | 0.56 |
| diamine | | | |
| UV Inhibitors & Antioxidants Blend | 1.06 | 0 | 1.59 |
| FeO - Black | 5 | 0 | 1.35 |
| Aspartic Ester & Aliphatic Carboxylic | | (279) | 9.54 |
| Ester Blend | | | |
| Totals | | | 100.00 |

The present disclosure is not limited to the above-mentioned embodiments. The above-mentioned embodiments are exemplification, and any one that has substantially the same constitution as one that the technical idea described in the claim of the present disclosure and exerts similar effect is included in the technical scope of the present disclosure.

What is claimed is:

1. A composite structure, comprising:
a substrate;
a first coating layer arranged on the substrate; and
a second coating layer arranged on the first coating layer such that the first coating layer is between the substrate and the second coating layer,
wherein:
the substrate comprises at least one substrate material selected from the group consisting of an asphalt shingle, a fiberglass shingle, asphalt, a bituminous material, roofing tar, EPDM, roofing paper, TPO, PVC, ketone ethylene ester, and a siding material,
the second coating layer comprises at least one coating material selected from the group consisting of an acrylic resin, a PVDF resin, a polyurea resin, a polyurethane resin, an epoxy resin, a polyurea-polyurethane hybrid resin, and combinations and hybrids thereof, and
the first coating layer comprises a mixture of the at least one substrate material and the at least one coating material.

2. The composite structure of claim 1, further comprising a third coating layer comprising at least one coating material selected from the group consisting of an acrylic resin, a PVDF resin, a polyurea resin, a polyurethane resin, an epoxy resin, a polyurea-polyurethane hybrid resin, and combinations and hybrids thereof.

3. The composite structure of claim 1, further comprising an aggregate layer arranged on the second coating layer, the aggregate layer comprising at least one aggregate material selected from the group consisting of inorganic sands, silica sand, silicas, silicates, oxides, coal slag, glass microspheres, ceramics, ceramic microspheres, abrasive media, photoluminescent aggregate, IR reflective aggregate, organo-metallics, polyurea, polyurethane, epoxy, PVDF, PVC, PC, TPO, PTFE, and particulate minerals.

4. The composite structure of claim 3, wherein the aggregate layer reflects, diffracts, or absorbs at least one selected from the group consisting of ultraviolet radiation, visible light and infrared radiation.

5. The composite structure of claim 1, wherein the second coating layer has a thickness in a range of from 5 mils to 250 mils.

6. The composite structure of claim 2, wherein the third coating layer has a thickness in a range of from 5 mils to 250 mils.

7. A method of applying a coating to a substrate, comprising:
spraying a coating mixture comprising a coating compound and a dissolving solvent onto the substrate;
partially dissolving the substrate with the dissolving solvent,
thereby allowing the coating mixture to partially mix with the substrate to form a first coating layer on the substrate; and
forming a second coating layer from the coating compound on the first coating layer,
wherein:
the second coating layer comprises at least one coating material selected from the group consisting of an acrylic resin, a PVDF resin, a polyurea resin, a polyurethane resin, an epoxy resin, a polyurea-polyurethane hybrid resin, and combinations and hybrids thereof,
the substrate comprises at least one substrate material selected from the group consisting of an asphalt shingle, a fiberglass shingle, asphalt, a bituminous material, roofing tar, EPDM, roofing paper, TPO, PVC, ketone ethylene ester, and a siding material,
the first coating layer comprises a mixture of the at least one substrate material and the at least one coating material, and
the dissolving solvent is a solvent that is at least partially miscible with the second coating layer and is capable of at least partially dissolving the substrate material.

8. The method of claim 7, wherein the coating compound comprises a first reactant and a second reactant.

9. The method of claim 8, wherein:
the first reactant comprises a precursor compound comprising at least two isocyanate groups, and
the second reactant includes at least one selected from the group consisting of a compound having more than one primary or secondary amine, a compound having more than one alcohol group, and a compound having more than one aspartic ester group.

10. The method of claim 7, wherein the solvent comprises at least one selected from the group consisting of acetone, methylethylketone, tetrachloroethylene, butyl acrylate, dibutyl amine, lacquer solvent, methylene chloride, naptha, tetrachloroethylene, acetone, diesel fuel, amyl chloride, ethylene chloride, n-butyl acetate, methyl isobutyl ketone, chlorobenzene, dibutyl phthalate, toluene, and xylenes.

11. The method of claim 10, wherein the solvent has a concentration of 0.1 vol % to 20 vol % in the coating mixture.

12. The method of claim 10, wherein the solvent has a concentration of 1.5 vol % to 3.9 vol % in the coating mixture.

13. The method of claim 10, wherein the solvent has a concentration of 0.05 vol % to 1.0 vol % in the coating mixture.

14. The method of claim 8, wherein the ratio of equivalents of the first reactant to equivalents of the second reactant in the coating mixture is from 0.95:1 to 1:0.95.

15. The method of claim 8, wherein the ratio of equivalents of the first reactant to equivalents of the second reactant in the coating mixture is from 0.95:1 to 1.40:1.

16. The method of claim 9, wherein the ratio of equivalents of the first reactant to equivalents of the second reactant in the coating mixture is from 0.98:1 to 1.15:1.

17. The method of claim 7, wherein the coating mixture is sprayed onto the substrate with a spray pattern that has a rectangular cross-section.

18. The method of claim 7, wherein the coating mixture is sprayed at a spray pressure of from 2 psi to 40 psi.

19. The method of claim 7, wherein the coating mixture is sprayed at a spray pressure of from 35 psi to 350 psi.

20. The method of claim 7, wherein the coating mixture is sprayed at a spray pressure of from 350 psi to 3500 psi.

21. The method of claim 9, wherein the second reactant has a hyperbranched or a dendrimer structure.

22. The method of claim 7, wherein an average particle size of coating compound is greater than 1 μm when the coating mixture is sprayed onto the substrate.

23. The method of claim 8, wherein an average particle size of coating compound is from 1 μm to 5 mm when the coating mixture is sprayed onto the substrate.

24. A method of applying a coating to a substrate, comprising:
applying a coating mixture comprising a coating compound and a dissolving solvent onto the substrate by rolling, brushing or squeegeeing;
partially dissolving the substrate, thereby allowing the coating mixture to partially mix with the substrate to form a first coating layer on the substrate; and
forming a second coating layer from the coating compound on the first coating layer,
wherein:
the second coating layer comprises at least one coating material selected from the group consisting of an acrylic resin, a PDVF resin, a polyurea resin, a polyurethane resin, an epoxy resin, a polyurea-polyurethane hybrid resin and combinations and hybrids thereof,
the substrate comprises at least one substrate material selected from the group consisting of an asphalt shingle, a fiberglass shingle, asphalt, a bituminous material, roofing tar, EPDM, roofing paper, TPO, PVC, ketone ethylene ester, and a siding material,
the first coating layer comprises a mixture of the at least one substrate material and the at least one coating material, and
the dissolving solvent is a solvent that is at least partially miscible with the second coating layer and is capable of at least partially dissolving the substrate.

25. The method of claim 24, wherein the coating compound comprises a first reactant and a second reactant.

26. The method of claim 25, wherein:
the first reactant comprises a precursor compound comprising at least two isocyanate groups, and
the second reactant comprises at least one selected from the group consisting of a compound having more than one primary or secondary amine, a compound having more than one alcohol group, and a compound having more than one aspartic ester group.

27. The method of claim 24, wherein the solvent comprises at least one selected from the group consisting of acetone, methylethylketone, tetrachloroethylene, butyl acrylate, dibutyl amine, lacquer solvent, methylene chloride, naptha, tetrachloroethylene, acetone, diesel fuel, amyl chloride, ethylene chloride, n-butyl acetate, methyl isobutyl ketone, chlorobenzene, dibutyl phthalate, toluene, and xylenes.

28. The method of claim 24, wherein the solvent has a concentration of 0.1 vol % to 20 vol % in the coating mixture.

29. The method of claim 24, wherein the solvent has a concentration of 1.5 vol % to 3.9 vol % in the coating mixture.

30. The method of claim 25, wherein the ratio of equivalents of the first reactant to equivalents of the second reactant in the coating mixture is from 0.95:1 to 1:0.95.

31. The method of claim 26, wherein the second reactant has a hyperbranched or a dendrimer structure.
